(19) United States
(12) Patent Application Publication
(10) Pub. No.: US 2008/0115077 A1
(43) Pub. Date: May 15, 2008

(54) PERSISTENT STATUS INDICATOR FOR CALENDAR

(75) Inventors: James L. Cooper, Tyngsboro, MA (US); A. Julie Kadashevich, Tyngsboro, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/558,164

(22) Filed: Nov. 9, 2006

(51) Int. Cl. G06F 3/048

(52) U.S. Cl. 715/772

(57) ABSTRACT

A computer program product and method for providing a persistent status indicator color for a nearest scheduled event are presented and calls for inputting preferences; categorizing the nearest scheduled event; and displaying the status indicator color for the nearest scheduled event.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to computer implemented personal calendars.

2. Description of the Related Art

Many important events, such as meetings, appointments, and classes, are missed because a person simply forgot a schedule for the event. Events can be. As one in the business world knows, missed events are inefficient and wasteful. A person scheduling the event may have to reschedule the event because of poor attendance. Anyone who has missed a doctor's appointment knows that there may be a long wait for the next available appointment. Missed events can be costly in both time and money.

Many people today in business and in private lives maintain an electronic calendar on a computing system. The electronic calendar provides a list of scheduled events. The list may include the time and date of the event.

Attempts have been made to address the problem of forgetting about scheduled events. The attempts have focused on ways to remind users using the electronic calendar. For example, an audio or visual alarm may activate in the calendar. One problem with alarms is that once they are activated and accepted, the alarm goes away. Alarms can be intrusive causing a user to lose concentration. Additionally, alarms may not be programmed ideally to provide adequate warning. For instance, with the alarm programmed too far in advance, the user may still forget about the event. With the alarm programmed too late, the user may not have adequate time to prepare for the event.

Another problem with calendar alarms is that the calendar application must be opened for the alarms to work. If the calendar is closed, the user will not receive any warning.

What are needed are software and hardware to provide a persistent status indicator of upcoming scheduled events.

### SUMMARY OF THE INVENTION

The shortcomings of the prior art are overcome and additional advantages are provided through the provision of a computer program product stored on machine readable media including machine readable instructions for providing a persistent status indicator color for a nearest scheduled event, the instructions for implementing a method include inputting preferences; categorizing the nearest scheduled event; and displaying the status indicator color for the nearest scheduled event.

Also disclosed is a computer system including a computer program product having instructions for providing a persistent status indicator color for a nearest scheduled event, the product includes instructions for inputting preferences; establishing default preferences for time intervals and associated status indicator colors; inputting user preferences; receiving scheduled event information from an electronic calendar; receiving scheduled event information automatically; receiving scheduled event information as a result of a request; selecting the nearest scheduled event; categorizing the nearest scheduled event; selecting the status indicator color; displaying the status indicator color for the nearest scheduled event; displaying the status indicator color on the desktop; displaying the status indicator color with selected displays; and displaying the status indicator color in the electronic calendar.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### TECHNICAL EFFECTS

As a result of the summarized invention, technically we have achieved a solution in which a computer program product stored on machine readable media includes machine readable instructions for providing a persistent status indicator color for a nearest scheduled event, the instructions for implementing a method include inputting preferences; categorizing the nearest scheduled event; and displaying the status indicator color for the nearest scheduled event.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts aspects of a computing infrastructure for implementation of the teachings herein;

FIG. 2 depicts aspects of the logic for providing the status indicator color for the nearest scheduled event;

FIG. 3 depicts aspects of one exemplary example of a desktop used to display the status indicator color for the nearest scheduled event; and

FIG. 4 presents a method for providing the status indicator color for the nearest scheduled event.

The detailed description explains the preferred embodiments of the invention, together with advantages and features, by way of example with reference to the drawings.

### DETAILED DESCRIPTION OF THE INVENTION

The teachings provide for, among other things, a method for providing a persistent status indicator for scheduled events. The persistent status indicator is included as a part of, or as an enhancement to, a computer implemented calendar program (i.e., application). The status indicator (typically in the form of a displayed color) provides warning of the approach of the nearest scheduled event. In one embodiment, the persistent status indicator color is coordinated with the time remaining before the occurrence of the nearest scheduled event. Typically, the status indicator color is always visible (i.e., persistent) as long as a computer system hosting the calendar is on. In one embodiment, the status indicator color is present with at least one of the computer desktop system tray indicators. The presence of the status indicator color is not dependent on the electronic calendar application being open.

As used herein, the term “scheduled event” refers to any event scheduled in the electronic calendar. The term “nearest scheduled event” refers to the scheduled event with the shortest period of time remaining before occurrence of the event. The term “desktop” refers to a metaphor for a graphical user interface in a computer operating system. The term “system tray indicators” refers to operating system indicators that appear on the desktop regardless of the application.

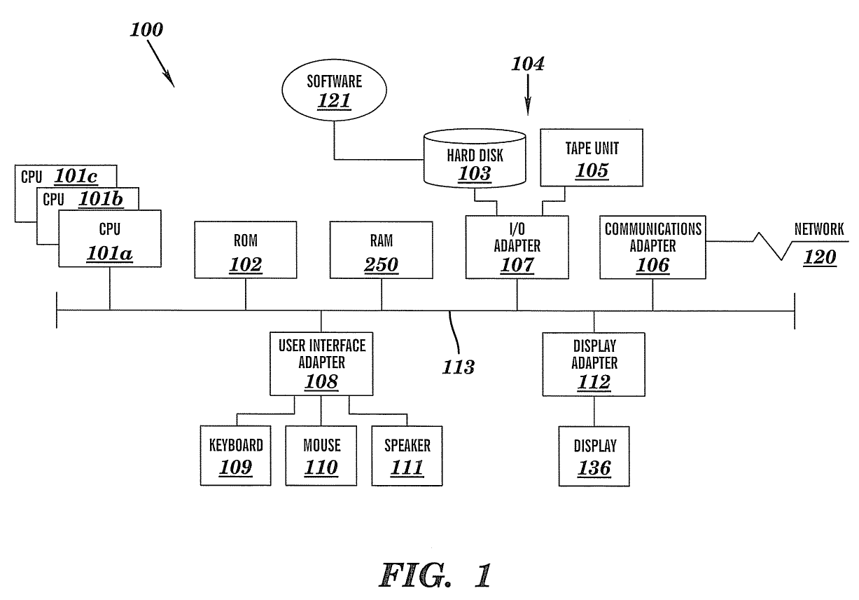

Referring now to FIG. 1, an embodiment of a computer processing system 100 for implementing the teachings herein is depicted. System 100 has one or more central processing units (processors) 101a, 101b, 101c, etc. (collectively or generically referred to as processor(s) 101). In one embodiment, each processor 101 may include a reduced instruction set computer (RISC) microprocessor. Processors 101 are coupled to system memory 250 and various other components via a system bus 113. Read only memory (ROM) 102 is coupled to the system bus 113 and may include a basic input/output system (BIOS), which controls certain basic functions of system 100.

FIG. 1 further depicts an I/O adapter 107 and a network adapter 106 coupled to the system bus 113. I/O adapter 107 may be a small computer system interface (SCSI) adapter that communicates with a hard disk 103 and/or tape storage drive 105 or any other similar component. I/O adapter 107, hard disk 103, and tape storage device 105 are collectively referred to herein as mass storage 104. The network adapter 106 interconnects bus 113 with a network 120 enabling data processing system 100 to communicate with other such systems. The network 120 can be a local-area network (LAN), a metro-area network (MAN), or wide-area network (WAN), such as the Internet or World Wide Web. Display monitor 136 is connected to system bus 113 by display adaptor 112, which may include a graphics adapter to improve the performance of graphics intensive applications and a video controller. In one embodiment, adapters 107, 106, and 112 may be connected to one or more I/O busses that are connected to system bus 113 via an intermediate bus bridge (not shown). Suitable I/O buses for connecting peripheral devices such as hard disk controllers, network adapters, and graphics adapters typically include common protocols, such as the Peripheral Components Interface (PCI). Additional input/output devices are shown as connected to system bus 113 via user interface adapter 108 and display adapter 112. A keyboard 109, mouse 110, and speaker 111 all interconnected to bus 113 via user interface adapter 108, which may include, for example, a Super I/O chip integrating multiple device adapters into a single integrated circuit.

As disclosed herein, the system 100 includes machine readable instructions stored on machine readable media (for example, the hard disk 103) for providing the persistent status indicator color. As disclosed herein, the instructions are referred to as persistent status indicator color software 121. The software 121 may be produced using software development tools as are known in the art. The software 121 may be provided as an “add-in” to an application (where “add-in” is taken to mean supplemental program code as is known in the art). In such embodiments, the software 121 replaces or supplements structures of the application for providing event status indication.

Exemplary calendar applications for talking advantage of the teachings herein include, for example, LOTUS NOTES, a product of International Business Machines, Inc. of Armonk N.Y., and OUTLOOK, a product of Microsoft Corporation of Redmond Wash. These examples are merely illustrative and are not limiting of the teachings herein.

Thus, as configured FIG. 1, the system 100 includes processing means in the form of processors 101, storage means including system memory 250 and mass storage 104, input means such as keyboard 109 and mouse 110, and output means including speaker 111 and display 136. In one embodiment a portion of system memory 250 and mass storage 104 collectively store an operating system such as the AIX® operating system from IBM Corporation to coordinate the functions of the various components shown in FIG. 1.

It will be appreciated that the system 100 can be any suitable computer (e.g., 486, Pentium, Pentium II, Macintosh), Windows-based terminal, wireless device, information appliance, RISC Power PC, X-device, workstation, mini-computer, mainframe computer, cell phone, personal digital assistant (PDA) or other computing device.

Examples of operating systems supported by the system 100 include Windows 95, Windows 98, Windows NT 4.0, Windows XP, Windows 2000, Windows CE, Macintosh, Java, LINUX, and UNIX, or any other suitable operating system.

Users of the system 100 can connect to the network 120 through any suitable connection, such as standard telephone lines, digital subscriber line, LAN or WAN links (e.g., T1, T3), broadband connections (Frame Relay, ATM), and wireless connections (e.g., 802.11(a), 802.11(b), 802.11(g)).

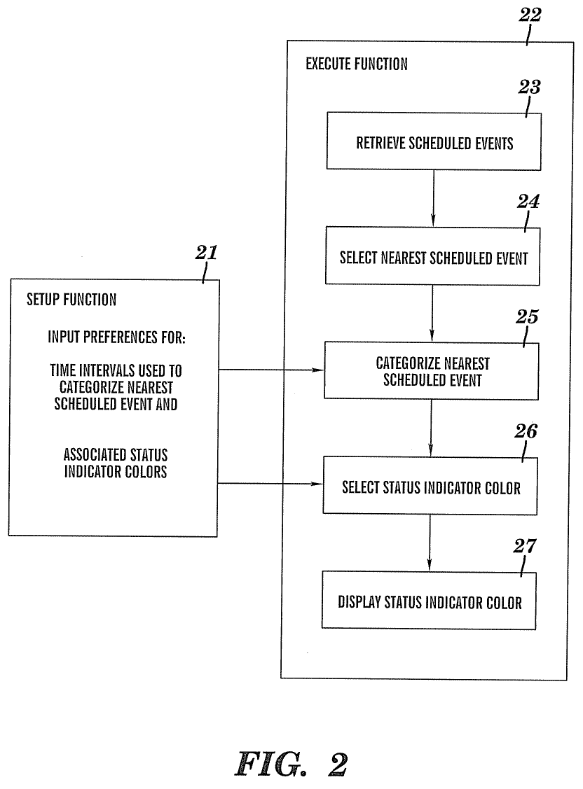

FIG. 2 depicts aspects of the logic for providing the status indicator color for the nearest scheduled event. Referring to FIG. 2, the software 121 provides for a setup function 21 and an execution function 22. The setup function 21 allows inputting, among other things, preferences for time intervals and associated status indicator colors. The time intervals are periods of time into which the time to the nearest scheduled event falls into. Typically, each of the time intervals has an associated status indicator color. For example, in one exemplary embodiment, a first time interval may be 0 to 24 hours and the associated status indicator color may be red. A second time interval may be 24 to 48 hours and the associated status indicator color may be yellow. A third time interval may be 48 hours or greater and the associated status indicator color may be green. Other time intervals and colors may also be input into the setup function 21.

Using the preferences input into the setup function 21, the execution function 22 provides a display of the status indicator color based upon the remaining time to the nearest scheduled event. The execution function 22 provides for a persistent display of the status indicator color.

A retrieving function 23 provides for retrieving information about the scheduled events. In one exemplary embodiment, the information is retrieved from the electronic calendar. In one embodiment, the calendar may provide the information automatically. Alternatively, the calendar may provide the information in response to a request by the retrieving function 23. The calendar application does not necessarily have to be open to send the information.

A selecting function 24 selects the nearest scheduled event from the information provided by the retrieving function 23.

A categorizing function 25 categorizes the nearest scheduled event. “Categorizing” is the process of determining into which time interval the time remaining to the nearest scheduled event falls into. The time intervals are input from the setup function 21.

A coloring function 26 selects the status indicator color. The color is based on the categorization of the nearest scheduled event and the color preferences input from the setup function 21.

A displaying function 27 displays the status indicator color. Typically, the displaying function 27 provides for displaying the status indicator color on the display 136. Using the example above, if the nearest scheduled event is scheduled to occur in 30 hours, the displaying function 27 will display the status indicator color yellow. The color yellow is displayed because the nearest scheduled event falls within the second time interval.

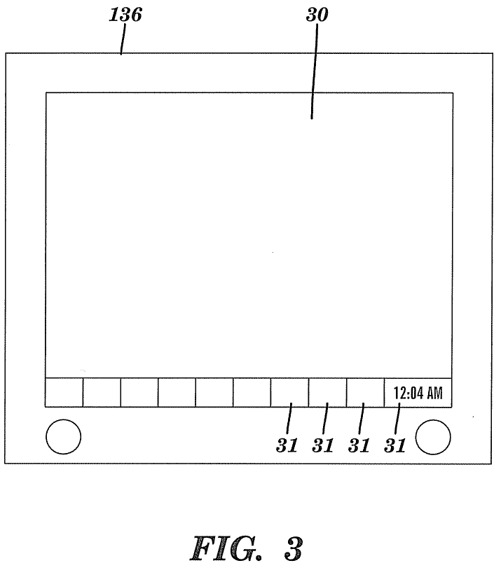

FIG. 3 depicts aspects of one exemplary example of a desktop used to display the status indicator color for the nearest scheduled event. The display 136 displays a desktop 30. The desktop 30 includes a plurality of system tray indicators 31. In one exemplary embodiment, the background of any of the indicators 31 may be selected to display the status indicator color. For example, the background of the indicator 31 associated with the clock may display the status indicator color. Other types of displays for the status indicator color may be designated for the desktop 30. For example, an icon may be designated to display the status indicator color. Also, the status indicator color may be displayed with selected applications, such as the calendar for example.

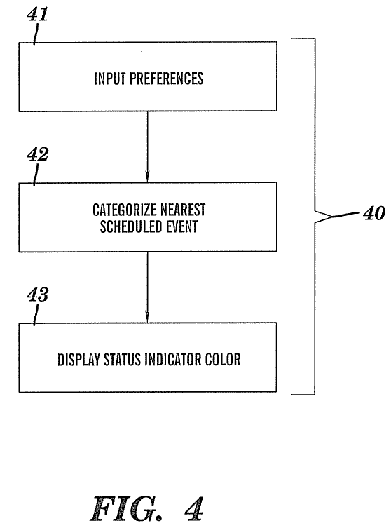

FIG. 4 presents a method 40 for providing the status indicator color. A first step 41 calls for inputting preferences. The first step 41 includes inputting preferences such as time intervals with which to categorize the nearest scheduled event. The first step 41 also includes inputting status indicator colors associated with the time intervals. Typically, the user inputs the preferences. In one embodiment, if the user does not input the preferences, the software 121 will input default preferences. A second step 42 includes categorizing the nearest scheduled event. Typically, the second step 42 includes receiving scheduled event information. Also, typically, the second step 42 includes selecting the nearest scheduled event from the scheduled event information. A third step 43 includes displaying the status indicator color. Typically, the third step 43 includes selecting the status indicator color based on at least one of user preferences and default preferences.

The teachings provide for the software 121 to include additional ways to indicate status. For example, the persistent status color may be programmed to blink at a selected rate. The process of providing the persistent status color includes providing the additional ways to indicate status. Preferences for the additional ways are input as part of the first step 41. The third step 43 includes displaying the additional ways to indicate status.

The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A computer program product stored on machine readable media comprising machine readable instructions for providing a persistent status indicator color for a nearest scheduled event, the instructions for implementing a method comprising:
inputting preferences;
categorizing the nearest scheduled event; and
displaying the status indicator color for the nearest scheduled event.

2. The computer program product as in claim 1, further comprising establishing default preferences for time intervals and associated status indicator colors.

3. The computer program product as in claim 1, further comprising inputting user preferences.

4. The computer program product as in claim 1, further comprising receiving scheduled event information from an electronic calendar.

5. The computer program product as in claim 4, further comprising receiving scheduled event information automatically.

6. The computer program product as in claim 4, further comprising receiving scheduled event information as a result of a request.

7. The computer program product as in claim 1, further comprising selecting the nearest scheduled event.

8. The computer program product as in claim 1, further comprising selecting the status indicator color.

9. The computer program product as in claim 1, further comprising displaying the status indicator color on the desktop.

10. The computer program product as in claim 1, further comprising displaying the status indicator color with selected applications.

11. The computer program product as in claim 1, further comprising displaying the status indicator color in an electronic calendar.

12. The computer program product as in claim 1, wherein the product is an add-in.

13. The computer program product as in claim 1, wherein the product is integrated into a calendar application.

14. A computer system comprising a computer program product having instructions for providing a persistent status indicator color for a nearest scheduled event, the product comprising instructions for:
inputting preferences;
establishing default preferences for time intervals and associated status indicator colors;
inputting user preferences;
receiving scheduled event information from an electronic calendar;
receiving scheduled event information automatically;
receiving scheduled event information as a result of a request;
selecting the nearest scheduled event;
categorizing the nearest scheduled event;
selecting the status indicator color;
displaying the status indicator color for the nearest scheduled event;
displaying the status indicator color on the desktop;
displaying the status indicator color with selected applications; and
displaying the status indicator color with the electronic calendar.
